(19) United States
(12) Patent Application Publication
(10) Pub. No.: US 2011/0023792 A1
(43) Pub. Date: Feb. 3, 2011

(54) METHOD AND DEVICE FOR DETERRING EARTH-BOUND ANIMALS AND/OR BIRDS

(76) Inventor: Peter Osypka, Rheinfelden-Herten (DE)

Correspondence Address: VOLPE AND KOENIG, P.C., UNITED PLAZA, 30 SOUTH 17TH STREET, PHILADELPHIA, PA, 19103, US

(21) Appl. No.: 12/839,659

(22) Filed: Jul. 20, 2010

(30) Foreign Application Priority Data
Aug. 1, 2009 (DE) 102009035808.0-23

(51) Int. Cl. A01K 15/04

(52) U.S. Cl. 119/721

(57) ABSTRACT

A method for deterring earth-bound animals (9) and/or birds from at least one area (2, 19) of the ground provides that, at sections of the perimeter (20, 21) of the area (2, 19) spaced apart from each other, one electrode (4, 5, 14, 15) each of a pair of electrodes is arranged and is made to electrically contact the ground (11) and the electrodes (4, 5, 14, 15) are each electrically connected to a voltage terminal (17) of a voltage source (7), with the voltage source (7) generating a preferably pulsing current flow through the area (2, 19) between the electrodes (4, 5, 14, 15).

### CROSS-REFERENCE TO RELATED APPLICATIONS

This application claims the benefit of German Patent Application No. 10 2009 035 808.0-23, filed Aug. 1, 2009, which is incorporated herein by reference as if fully set forth.

### BACKGROUND

The invention relates to a method for deterring earth-bound animals and/or birds from at least one area of the grounds of an airport. The invention further relates to a device for deterring earth-bound animals and/or birds from at least one area of the grounds of an airport.

It is known that every year a lot of damage in airplanes is caused by bird strikes. It is therefore desirable to reduce the risk of birds colliding with airplanes by keeping the birds away from airports.

For this purpose, so-called detonators are used, in which small boxes are placed next to the runways, which trigger a detonation upon activation by the tower personnel in order to drive away flocks of birds. Alternatively, small explosives and detonation pistols are used to chase away the birds.

Further, methods are known, in which a tape with bird sounds is played via loud speakers with the bird sounds previously being taped during emergency situations, intending to frighten the real birds.

It is further known to employ so-called bird chasers on airports and to hold falcons or buzzards that are intended to chase away other birds.

It is also known to keep the grass between the runways of airports at a length ranging from 10 to 40 cm preventing any birds from nesting.

It has shown that the above-described methods and devices are relatively expensive in their operation and of poor reliability.

In order to deter any larger earth-bound animals, additionally electric fences are known, which are of no effect for birds and small animals, although.

For example, from U.S. Pat. No. 6,173,942 an electric chain-link fence is known, which comprises horizontally and vertically extending twigs, with only some of the horizontal twigs being made from a conducting material and the other ones from a non-conducting material. This chain-link fence is not suitable to deter birds, though.

### SUMMARY

The invention is based on the object of providing a device and a method of the type mentioned at the outset, which allows a simplified operation and is at least sufficiently reliable.

This objective is attained by a device and method according to the invention.

In a method according to the type mentioned at the outset it is provided that at least one area is impinged with a voltage at its perimeter, generating an electric current flow through said area, that at least one area is impinged with an alternating voltage generating an electric current flow with a sequentially alternating direction of flow through at least one area, that two pairs of spaced-apart, uncoated electrodes at the perimeters of at least one area are impinged alternating with a voltage, with the directions of the electric flux lines respectively created alternating by said pairs intersecting, and that at least said one area is arranged or installed in the immediate proximity of a runway of the airport and is impinged with a voltage.

Here, it is advantageous that, simultaneously to the current flowing in the respective area, a potential difference is implemented over the direction of flow, at least at the surface, which also remains essentially intact when a bird or an earth-bound animal with its extremities causes short-circuiting over a section along the direction of flow. The animal will then feel an unpleasant electric pulse in form of a potential difference and leave the area. This way, safety-relevant sections of the airport are kept free from animals in a simple and effective manner, which otherwise cause a risk of collision with airplanes that are taking-off or landing. It has shown that animals are very sensitive with regards to electric fields in their motor skill-functions, particularly in the area of their extremities. This way, birds and small earth-bound animals such as rabbits and the like can be kept away from safety-relevant areas and/or sections of crops worth protecting.

In order to avoid that the animal stands in a preferred position perpendicularly in reference to the direction of the current and thus can avoid the effects of the electric pulse it is provided according to the invention that at least one area is impinged alternating or sequentially with differently aligned voltages, thus generating an electric current flow in at least one area, preferably a single, for example, pulsed current flow, having a sequentially alternating direction of flow. Here, the direction of flow is determined as the average value of the directions of the local current density in said area. Thus, the field direction of the electric flux lines extending in the ground are changed over time, for example by being impinged alternating or successively with voltages via electrodes arranged at various positions.

Due to the fact that at the perimeters of at least one area, particularly at opposite sides, two pairs of distanced, uncoated electrodes are alternately impinged with a voltage, with the directions of the electric flux lines alternating and created by the pairs respectively intersecting, the directions of the respective local flow densities created, i.e. the local directions of current flow or the current pulses, also intersect in the same manner.

One embodiment of the invention provides for at least one area of the ground to be impinged with successive voltage pulses, by which the respective electric current pulses are generated in at least one area. This results in a simple way of embodying the invention, namely by using electric pulses of a short duration and high voltages, such as the ones used in electric fences. Therefore, electric pulses having voltages reaching and exceeding 10,000 V are created, having an pulse duration of less than 1 s, for example 0.1 s or less, and pulse energies of 1 J or more, for example 5J. However, unlike electric fences, according to the present invention the electric fields are created at the ground surface and cause an electric current, here.

In order to ensure that the electric pulses can be sensed by the animals it may be provided that a voltage is used that creates an electric current flow in at least one area, having a potential difference over a distance of 1 cm or 5 cm or 10 cm in at least said area, which can be felt by birds and/or earth-bound animals. The extent of the voltage used is therefore selected depending on the size of at least one area. It may also be provided that the amount of the voltage is varied in order to avoid effects of familiarization and/or to adjust the method to other conditions, for example soil humidity. Overall it may be provided that the intensity of the pulses, determined at least by the parameters voltage, duration of pulses, duration of pauses, and/or frequency, is varied and adjusted to the respective conditions, for example the weather and/or the number of animals present in the close proximity.

Particularly beneficial results are achieved when an area is arranged or installed in the immediate proximity of a runway of the airport or an agriculturally used area and is impinged with an electric current. The immediate proximity of the runway comprises adjacent parts of the grounds, from which birds and earth-bound animals can quickly reach the runway or the airspace thereabove and may cause collisions with airplanes that are taking off and landing. The immediate proximity of an agriculturally used area particularly comprises the edges of the fields or boundary ridges, which shall keep animals away from entering the field or the agriculturally used area. The installation occurs by placing the electrodes in or upon the ground surface.

In order to save energy it may be provided that several areas of the ground surface separated from each other, for example of the airport or the field, are successively impinged with a voltage or a sequence of voltages. The area of the airport, particularly the unused cleared areas of an airport, and/or the area of the field can therefore be divided into sections subjected sequentially and/or as needed to the method according to the invention.

The current flow through the area can be generated in a simple manner when in their operational position the electrodes are buried at least half-way, particularly at such a depth that their exterior surface facing upwards ends flush with the ground surface. For example, the electrodes can be isolated at their exterior surface remaining outside the ground after being buried, while the exterior surface of the electrodes contacting the ground are at least partially exposed.

The device of the type mentioned at the outset provides at the perimeter of at least one area at least two distanced electrodes which contact the ground surface in an electric fashion. The electrodes are each connected to a terminal of a voltage source, the electrodes are arranged in pairs in reference to each other such that, with the voltage source between the electrodes being connected to the different terminals of the voltage source, a current flow can be generated between them through the area of the ground surface, and at least two pairs of electrodes are provided at the perimeter(s) or forming the perimeters of at least one area, with the electrodes being arranged such that the direction of extension of the current generated via the pair of electrodes is aligned perpendicularly in reference to the direction of extension of the current flow generated by the other pair of electrodes.

Here, it is advantageous that electric fields are generated right underneath or at the surface of the ground, which causes animals present at those areas to feel uncomfortable. The electric fields cause a current flow in the ground right underneath the surface, which corresponds to a potential difference along the direction of flow caused by the ohmic resistance. If said potential difference between sections is bridged by animals by way of them contacting the ground with their extremities in these areas, the animals feel in their body the potential difference as a so-called line-drop in the form of an electric pulse. Due to the fact that the animals are sensitive with regard to the electric fields, they will experience the presence in the area of the device as being unpleasant and will leave said area. This way, the risk of collisions with airplanes during take-off and landing is effectively reduced.

Here, it is particularly beneficial when the electrodes contact the ground surface in a linear fashion. Here, linear contacting represents a form of contacting that results from an electrode, with its geometric shape and thus its contacting sections showing a longitudinal extension, with the dimensions of the contacting sections or the geometric shape of the electrode being considerably smaller in reference to the longitudinal extension, preferably amounting to one tenth or less of the length along the longitudinal extension. Here, straight or curved or arched or differently embodied electrodes may be provided. The linear contacting results in a planar current flow through the area, which the animals can feel over said entire area.

In order to create a planar extending current flow through the area it may be provided that the electrodes are arranged in pairs, parallel in reference to each other and/or at opposite sides of at least one area.

In order to create electric fields below the ground surface it may be provided that in the operational position the electrodes are at least partially buried in the ground. For example, the electrodes may show a round or rectangular cross-section perpendicularly in reference to their longitudinal extension. For example, the electrodes may be buried half way with regards to their cross-section, perpendicularly to the direction of extension as defined by their longitudinal direction or in their entirety, and/or end flush with the ground surface. Said burying offers the additional advantage that the electrodes are protected from any unintended displacement. Alternatively or additionally, fastening means may be provided, for example pegs or anchors, to fasten the electrodes to the ground and/or for the purpose of contacting.

It is particularly effective if the voltage source provides means to create pulsed voltage. Such means may comprise a generator for pulsed voltages, for example.

In order to prevent any effects of familiarization or learning in the animals it is provided according to the invention that at least two pairs of electrodes are provided at the edges or embodying the edges of at least one area, with the electrodes being arranged such that the direction of a current flow, generated by the pair of electrodes spaced-apart in reference to each other, is aligned perpendicularly, particularly at a right angle, in reference to the direction of flow of the current generated by the other pair of electrodes distanced from each other. This way, it can be avoided that the animals learn a particular behavior, for example a preferred orientation, which allows them to be present in the area without feeling the electric pulses. This further increases the effectiveness of the device.

In order to vary the field direction and the direction of the current flow a multiplexer may be provided, by which the electrodes can be connected to the voltage source. The multiplexer may therefore successively connect different electrodes to the voltage source, respectively generating differently aligned current flows.

For example it may be provided that at least one area comprises the shape of a polygon and that the electrodes form opposite edges of said polygon. Here, at least one area may be embodied with a hexagonal, generally polygonal, or rectangular, or any other shape and/or it may be provided that the respectively opposite sides of at least one area are formed at least sectionally or entirely by the electrodes of a pair of electrodes, with the pair of electrodes being successively connected to the voltage source or can be connected thereto. Thus, using the pair of electrodes different patterns of the streamlines of the field can be generated, which form the total or the interference of a web of intersecting streamlines of the field.

If the unused free area of the airport or the field is divided into several sections, a multiplexer may be provided, by which the sections can optionally be and/or become impinged with voltages from the voltage source. This way, the various sections can be operated independent from each other successively and/or simultaneously, using the method according to the invention. The multiplexer may also be embodied to switch the pairs of electrodes of one section, or another multiplexer may be provided for said purpose. Here, a multiplexer is understood as a selective combinatory circuit, in general, by which the inputs, electrically connected to the voltage source, can optionally be electrically connected to the outputs, to which the electrodes are electrically connected.

In order to avoid effects of familiarization and/or to allow an adjustment to the conditions, such as weather and/or the number of animals present in the proximity or other parameters, means may be embodied to vary the magnitude and/or the duration of the pulses and/or the frequency of the voltages applied. Additionally, direct current pulses may be used.

### BRIEF DESCRIPTION OF THE DRAWINGS

In the following, the invention is explained using exemplary embodiments, however it is not limited to the exemplary embodiments. Additional exemplary embodiments result from a combination of one or more features of the claims with each other and/or with one or more features of the exemplary embodiments.

Shown in a schematic illustration are:

FIG. 1 a top view of an airport having a runway for take-off and landing and a device according to the invention,

FIG. 2 a top view of the potential difference in the area of a device according to the invention,

FIG. 3 a top view of the current flow in the area of a device according to the invention,

FIG. 4 a cross-sectional view of the progression of electric streamlines of the field and the current flow in the invention,

FIG. 5 a view showing the use of several pairs of electrodes in the invention, and

FIG. 6 a view showing the use of a multiplexer in the invention.

### DETAILED DESCRIPTION OF THE PREFERRED EMBODIMENTS

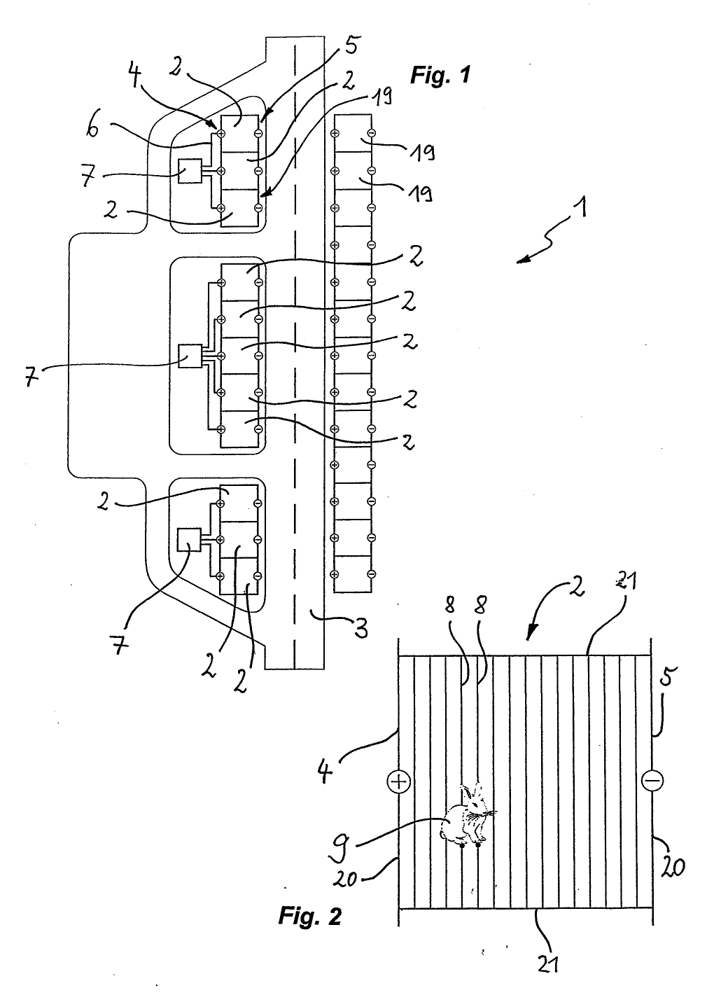

FIG. 1 shows an airport in a schematic illustration in principle, marked 1 in its entirety, in which areas 2 are to be kept free from earth-bound animals and/or birds, so that they stay away from the area of the runway 3, its surface, and the space thereabove.

At their perimeters, the areas 2 are provided with electrodes 4, 5, spaced apart in reference to each other and respectively marked “+” and “−”, which extend linearly straight along a section of the perimeter and contact the ground. For reasons of clarity, in FIG. 1 not all visible electrodes are separately marked with reference characters. If applicable, the electrodes 4 and/or 5 may also show a progression deviating from a straight line, for example to consider the respective topography or the local conditions.

The electrodes 4, 5 are connected via stylized illustrated connecting wires 6 to the terminals of a generator 7, which serves as the electric voltage source. Due to the fact that the electrodes 4, 5 are each arranged in pairs at opposite sides of the area 2, they generate a current flowing through the area 2, based on the conductivity of the ground, as soon as they are impinged with a voltage, emitted by the generator 7, via the connection wires 6 drawn as single lines only.

The current flow, preferably in the form of current pulses are generated, i.e. temporarily limited flows of direct or alternating current, is sensed by animals contacting the ground in the area 2 at least at two positions spaced from each other. Due to the fact that the sensation triggers an unpleasant feeling the animals are provoked to leave the area 2 and thus to stay away from the airport 1.

FIG. 2 shows a top view of an area 2 of FIG. 1 in a schematic illustration.

A rectangular area 2 is shown, which is limited at two opposite sides 20 by the electrodes 4, 5. The electrodes 4, 5 contact the ground of the area 2 in a linear fashion and thus form the perimeter of the area 2 at two opposite sides.

The two other limiting sides 21 of the area 2 result by the virtual connecting lines of the ends of the electrodes 4, 5, as illustrated.

FIG. 2 shows the distribution of voltage in the area 2, which develops between the electrodes 4, 5 due to the current flow.

Equi-potential areas 8 are shown, i.e. those points of the area 2, which show the same potential difference to the electrode 4 and/or to the electrode 5.

Here, the illustration of FIG. 2 shows an ideal state, not considering any deviations from the strictly parallel progression of the equi-potential areas 8 and the straight progression of the perimeters of the area 2, which are caused by the different conductivities in the ground and/or by edge effects of the current flow at the perimeters of the area 2. FIG. 2 rather illustrates the principle of the invention only, and it is obvious for one trained in the art how the above-described effects would change this illustration. If an animal 9 enters the area 2 and contacts said area 2, for example with its extremities, at two points spaced apart from each other, which are allocated to different equi-potential areas 8, the animal bridges with its body the potential difference between said equi-potential areas 8, thus triggering a current flow in the body of the animal 9, which is felt by the animal 9. Here, an earth-bound animal 9 is shown, however it may also represent a bird.

The unpleasant sensation connected to the current flow will provoke the animal 9 to leave this area 2.

Here, the current flow generated in the area 2 by the impingement of the electrodes 4, 5 with voltage from the generator 7 ensures that the voltage between the equi-potential areas 8 is not immediately collapsing when an animal 9 bridges it, but leading to a noticeable effect in the animal 9.

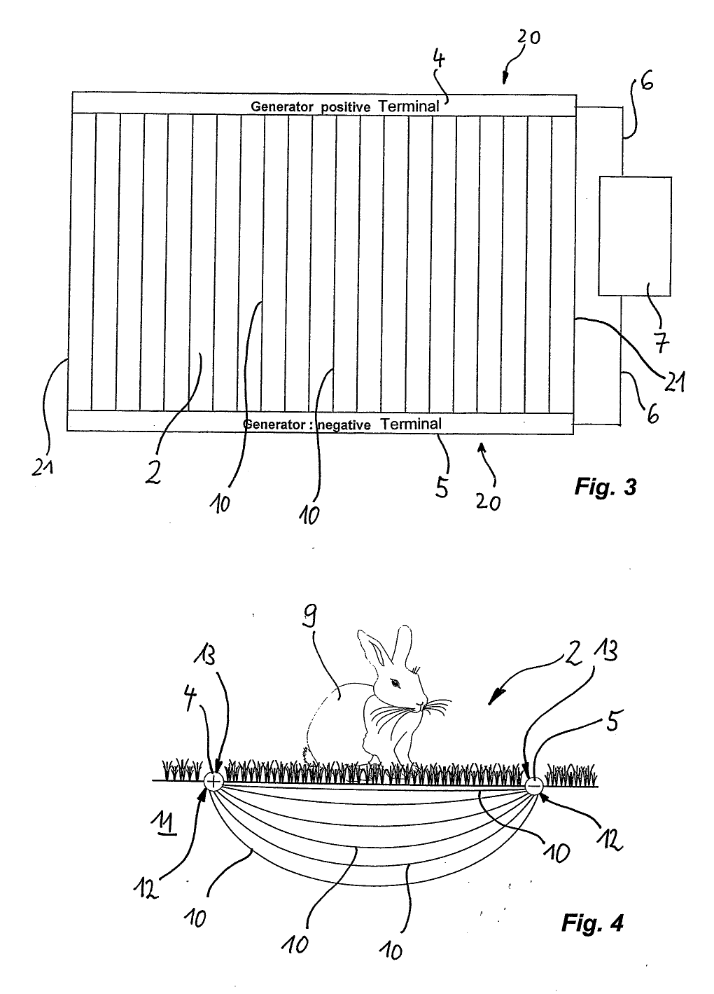

FIG. 3 shows the progression of the electric current flow in the area 2 generated by the voltage applied between the electrodes 4 and 5. The electric flux lines 10 indicating the local direction of progression of the electric flow are shown in a schematic illustration of the principle, which again ignores any deviations from the ideal form. The progression of the electric flux lines shown is here resulting in the idealized form because the electrodes 4, 5 contact the ground in a linear fashion over their longitudinal direction of extension.

It is clear that due to the resistance for the current flux in the ground this current flux results in a voltage distribution according to FIG. 2.

FIG. 4 shows a side view to the area 2 of FIG. 2, in which the ground 11 is sectioned. The progression of the flux lines between the electrodes 4 and 5 impinged with a voltage is shown once more in a schematic fashion, i.e. ignoring the particular conditions actually given, indicating the direction of current flow between the electrodes 4 and 5. In each point this direction of flow is aligned tangentially in reference to the flux lines 10 drawn in an exemplary fashion.

It is discernible that the electrodes generate a current flow through the area 2 from one electrode 4 to the other electrode 5, which largely extends in the proximity of the surface of the ground 11.

In the exemplary embodiment according to FIG. 4, the electrodes 4, 5 show a circular cross-section perpendicularly in reference to their linear direction of placement, and each are half-way buried into the surface of the ground 11.

In order to allow current to flow through the area 2 the electrodes 4, 5 are embodied uncoated at the semi-surfaces contacting the ground 11.

In a further development, the semi-surfaces 13 of the electrodes 4, 5 projecting from the ground 11 are coated with an insulating layer. However, they may also be embodied uncoated.

From the voltage distribution shown in FIG. 2 it is discernible that the animal 9 can avoid the unpleasant sensation caused by the current pulses in the area 2 by being aligned longitudinally in reference to the equi-potential areas 8 and only contacting points located on a single equi-potential area 8. Although this is hardly possible for four-legged animals; however two-legged animals, for example birds, can easily achieve it. Thus, there is the risk that the birds learn to always land in a certain alignment or direction in the area 2 in order to avoid feeling said voltage and/or current pulses.

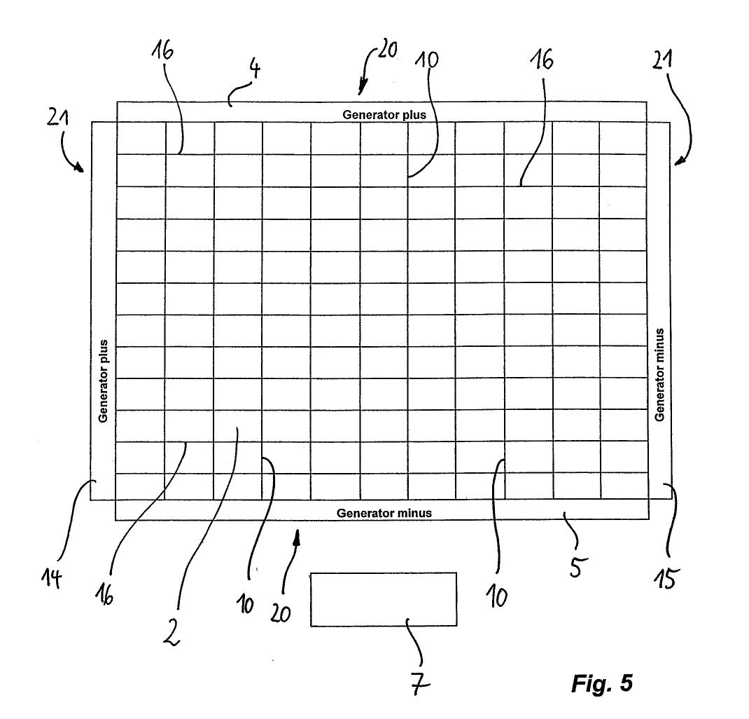

In order to prevent this effect, the perimeters of the area 2, shown clear in FIG. 2, may be provided with additional electrodes 14, 15 as illustrated in FIG. 5. Thus, the electrodes 4, 5, 14, 15 form the perimeters of the rectangular area 2. The electrodes 4, 5 form one pair of electrodes, and the electrodes 14, 15 form another pair of electrodes. Each pair of electrodes can be electrically connected to the generator 7, namely successively or alternating.

When the electrodes 4 and 5 are connected to the voltage terminals of the generator 7 a progression of the electric flux lines 10 results as shown in FIG. 3. This progression of flux lines causes, as described above, a current flow through the area 2, which extends along the flux lines 110 in the technical direction from the positive terminal 4 to the negative electrode 5.

However, if the electrodes 14, 15, also linearly contacting the ground 11, are electrically connected to the voltage terminals of the generator 7, electric flux lines 16 are generated in the area 2, with their direction of flow showing a right angle in reference to the direction of flow of the flux lines 10. In other words, the directions of progression of the flux lines 10 and the flux lines 16 intersect.

The flux lines 16 cause a current flow through the area 2, which is aligned in the technical direction from the positive electrode to the negative electrode 15 and with its direction of flow therefore intersecting the direction of progression of the current flow caused by the flux lines 10.

Therefore, if the electrodes 4, 5 on the one side and the electrodes 14, on the other side are alternating connected to the voltage terminals of the generator 7 a chronological succession of current flows develops in the area 2, with the direction of the current flow varying and/or alternating over the chronological succession. The above-mentioned bird had to change its orientation simultaneously with said alteration in order to avoid the unpleasant sensations. Since that is difficult if not impossible any bird will prefer to leave the area 2.

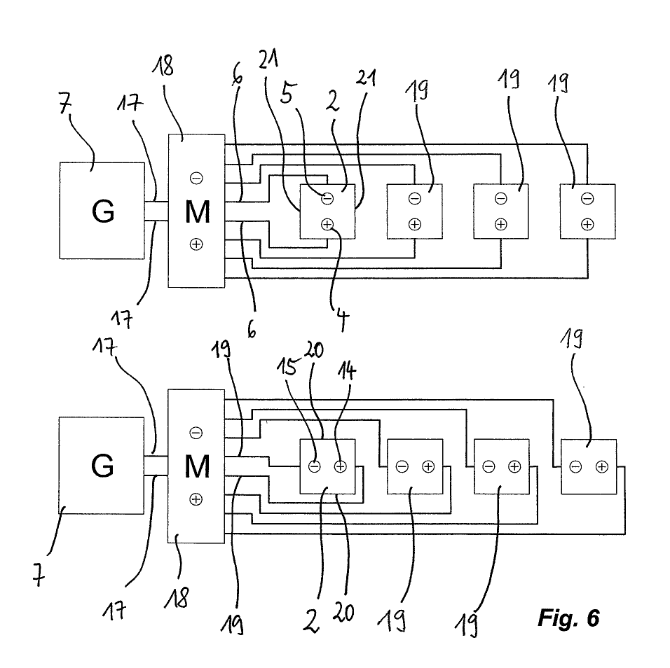

FIG. 6 shows in two schematic flow charts how the electrodes 4, 5, 14, 15, shown in FIG. 5 and arranged in pairs parallel in reference to each other and in pairs at opposite sides of the area 2, can be connected to the voltage terminals of the generator.

Here, the upper half of FIG. 6 shows one circuit variant and the lower half of FIG. 6 another circuit variant.

The voltage terminals 17 of the generator 7 are here connected to a multiplexer 18. The connecting wires 6 for the electrodes 4, 5 and the connecting wires 19 for the electrodes 14, 15 of the area 2 are connected to the outlet of the multiplexer 18. The multiplexer 18 can now accept two internal switching positions, with in the first switching position the positive electrode 4 is electrically connected via the connecting wire 6 to the positive terminal of the generator 7 and the negative electrode 5 via its connecting wire 6 through the multiplexer 18 to the negative voltage terminal of the generator 7. In another switching position, however, the connecting wires 19 are electrically guided to the voltage terminals 17 such that the electrodes 14, 15 are electrically connected to the voltage terminals 17 of the generator 7.

This way, for example by a clocked or manually triggered switching of the multiplexer it can be switched between the above-described switching statuses of the two field distributions 10, 16 according to FIG. 5.

The other areas 19 in FIG. 6 are embodied in the same manner as the described area 2.

In the exemplary embodiment it is now provided that the other areas 19 are operated synchronized to the area 2.

However, it may also be provided that the areas 19 are impinged with voltage from the multiplexer 18, when the area 2 is not operated, so that in the areas 2, 19 a current flow is caused in a chronological sequence. This may be already sufficient for many applications, because earth-bound animals 9 or birds, deterred after an electric shock, will not immediately return to the area 2, but rather leave the area 2 free from any animals 9 for a certain period of time. During said period, the animals 9 can be deterred from other areas 19.

The generator 7 and/or the multiplexer 19 comprise a circuit or other element, not shown in greater detail, to generate voltage pulses, by which current pulses can be created in the areas 2, 19.

In the method for deterring earth-bound animals 9 and/or birds from at least one area 2, 19 of the ground it is provided that sections of the perimeter 20, 21 of the area 2, 19, distanced from each other, each comprise an electrode 4, 5, 14, of a pair of electrodes and are made to electrically contact the ground 11 and that the electrodes 4, 5, 14, 15 are electrically connected to one voltage terminal 17 of an electric voltage source 7 each, with the electric voltage source 7 causing a preferably pulsed current flow through the area 2, 19 between the electrodes 4, 5, 14, 15.

1. A method for deterring earth-bound animals (9) and/or birds from at least one area (2, 19) of ground of an airport (1), comprising providing the at least one area (2, 19) arranged or installed in immediate proximity to a runway of an airport (1), using two pairs each of spaced apart, uncoated electrodes (4, 5, 14, 15) that are impinged alternately with the electric voltage at the perimeter (20, 21) of the at least one area (2, 19), with a direction of electric flux lines (10, 16) respectively created by said pairs each intersecting, impinging the electrodes in the at least one area (2, 19) at a perimeter (20, 21) thereof with an electric voltage, causing an electric current flow through the area (2, 19), wherein the at least one area (2, 19) is alternately impinged with differently aligned voltages, by which in the at least one area (2, 19) an electric current flow with a chronological sequence of alternating directions of progression is generated.

2. The method according to claim 1, wherein the at least one area (2, 19) is impinged with chronologically successive voltage pulses, each generating voltage pulses in the at least one area (2, 19).

3. The method according to claim 1, wherein the voltage is used, which generates a current flow in the at least one area (2, 19) comprises a potential difference over a distance of 1 cm or 5 cm or 10 cm or more, which can be sensed by birds and/or earth-bound animals (9).

4. The method according to claim 1, wherein there are several of the areas (2, 19) on the grounds of an airport (1), separated from each other, the method comprises successively impinging the areas with the voltage or a chronological succession of voltages.

5. The method according to claim 1, further comprising burying the electrodes (4, 5, 14, 15) at least half-way, such that in an operational position an exterior surface (13) of the electrodes pointing upwards ends flush with a surface of the area.

6. A device for deterring earth-bound animals (9) and/or birds from at least one area (2, 19) of grounds of an airport, comprising at least two pairs of electrodes (4, 5, 14, 15) provided at a perimeter of the at least one area (2, 19), which electrically contact the ground, the electrodes (4, 5, 14, 15) are connected to an electric voltage source (7), the pairs of electrodes (4, 5, 14, 15) are arranged such that by the voltage source (7) a current flow is generateable between the electrodes (4, 5, 14, 15) connected to different terminals (17) of the voltage source (7) over at the least one area (2, 19) of the grounds, and at the perimeter or perimeters (20, 21) of the at least one area (2, 19) the electrodes (4, 5, 14, 15) are arranged such that the direction of extension of the current flow generated by a first one of the pairs of electrodes (4, 5, 14, 15) is aligned perpendicularly in reference to a direction of progression of the current flow generated by the other of the pairs of electrodes (4, 5, 14, 15).

7. The device according to claim 6, wherein the electrodes (4, 5, 14, 15) contact the ground in a linear fashion.

8. The device according to claim 6, wherein the pairs of electrodes (4, 5, 14, 15) are arranged in at least one of pairs parallel in reference to each other or in pairs at opposite sides (20, 21) of the at least one area (2, 19).

9. The device according to claim 6, wherein the electrodes (4, 5, 14, 15) are at least partially buried in the ground.

10. The device according to claim 6, wherein the voltage source (7) comprises a circuit to create voltage pulses.

11. The device according to claim 6, wherein the at least one area (2, 19) has at least one of a form of a polygon or sides (20, 21) opposite the electrodes that form a polygon.

12. The device according to claim 6, wherein a multiplexer (18) is provided, by which the electrodes (4, 5, 14, 15) are connected to the voltage source (7).

13. The device according to claim 6, wherein a multiplexer (18) and several the areas (2, 19) of the ground are provided, and the areas (2, 19) can optionally be impinged by the multiplexer (18) with voltage from the voltage source (7).

14. The device according to claim 6, wherein the voltage source is embodied to vary at least one of the voltage amount, a pulse duration or a frequency of the applied voltages.
